(19) United States
(12) Patent Application Publication
(10) Pub. No.: US 2026/0050467 A1
(43) Pub. Date: Feb. 19, 2026

(54) NON-INTERACTIVE LEADERLESS TIMEOUTS IN DISTRIBUTED TRANSACTION MANAGEMENT SYSTEMS

(71) Applicant: IOV42 TECHNOLOGY GMBH, Wien (AT)

(72) Inventors: Mark Andrew Rainey, Hertfordshire (GB); Aldo Stracquadanio, London (GB); Ryan Christopher Worsley, Brighton (GB)

(21) Appl. No.: 19/101,146

(22) PCT Filed: Oct. 10, 2022
(86) PCT No.: PCT/EP2022/078151

§ 371 Date: Feb. 4, 2025

(51) Int. Cl. G06F 9/48; G06F 9/54

(52) U.S. Cl. CPC G06F 9/4812; G06F 9/4887; G06F 9/54; G06F 2209/544

(57) ABSTRACT

Method for interrupting an action in a parallel, distributed processing system (26) comprising at least two nodes (28, 29), and node (28; 29) configured to perform such a method as well as distributed transaction management system (26) comprising two or more such nodes (28, 29),
wherein each node (28, 29) stores an action log of pending actions, the method comprising the following steps carried out by at least one of the nodes:
receiving a logical time update from at least another one of the nodes,
merging the logical time update into a shared state to obtain an updated shared state,
determining a common logical time from the updated shared state,
checking each of the pending actions in the action log for a timeout condition based on the determined common logical time,
upon detecting a timeout of one of the pending actions, interrupting the action by the present node.

The invention concerns a method for interrupting an action in a parallel, distributed processing system comprising at least two nodes. In particular, the invention relates to a distributed transaction management system, wherein the present method can be used for interrupting a transaction.

In any parallel system it is a common requirement to detect when an action takes longer than expected, which could be due to a processing or communication error. Typically, such a detection is achieved by evaluating a timeout condition. There are different approaches to evaluating a timeout condition in a distributed system. One approach is to evaluate the timeout condition locally at each node. In order to achieve consistent behavior, the local clocks of the nodes may be synchronized via the Network Time Protocol (e.g., according to the proposed standard as documented in RFC 5905, IETF). This type of wall-clock synchronization cannot guarantee for a timeout event to happen at the very same moment across all nodes in a distributed system, because local times always vary at least slightly.

U.S. Pat. No. 983,981 B1 describes a distributed key-value database and how ACID conformance can be implemented. It contains descriptions of so-called time vendors, a number of separate processes that provide network time to the other processes. Those time vendor processes are organized as one leader and several standby processes. This protocol requires a central authority in the form of the centralized time vendor to be queried for a global time. And there is a significant overhead in terms of interactive communication between the time vendor processes in determining a time leader among them.

In their article “Optimizing jobs timeouts on clusters and production grids” Glatard et al (Seventh IEEE International Symposium on Cluster Computing and the Grid, IEEE, 2007) discuss strategies for a workload management system. They mention that timeouting and resubmitting abnormally long jobs is a common strategy and develop a model of the job execution time taking into account the timeout value and resubmissions. For their model, they assume different probability distributions for the system latency. The focus of the article lies on increasing the reliability of getting replies on requests while dynamically tuning timeout values for maximum performance. They find that the optimum timeout value depends on the chosen distribution. However, they assume a centralized cluster management system and do not deal with the practical problem of achieving a common concept of timeouts in a distributed system.

Leslie Lamport, in his Article “using Time Instead of Timeout for Fault-tolerant distributed systems.” (ACM Transactions on Programming Languages and Systems (TOPLAS) 6.2 (1984): 254-280) suggests the use of an integer logical time across nodes in a distributed system. This is actually a counter and not useful to set a timeout as a certain point on wall-clock time, as progression in this integer logical time relies on the reception of a next message containing a time increment. That next message will be received at some unknown future moment, or it might not be received at all. This leaves the system with varying response times and inconsistent performance, and sometimes stalling infinitely. This is a common issue of current distributed systems and their consensus algorithms.

Bryan Ford, in his article “Threshold logical clocks for asynchronous distributed coordination and consensus.” (arXiv preprint arXiv:1907.07010; 2019) introduces a threshold logical clock protocol, inspired by Lamport's vector clocks and matrix clocks. However, TLC also represents logical time steps as a single monotonically increasing integer. Nodes running asynchronously progress their logical time in lock-step. This comes at the cost of performance required to achieve a quorum for proceeding to the next step. Again, timeouts must be defined in monotonically incrementing time steps, without a clear relationship with a physical time duration, i.e., in wall-clock time.

Kulkarni, Sandeep S., et al. in their article “Logical physical clocks.” (International Conference on Principles of Distributed Systems. Springer, Cham, 2014) propose a hybrid logical clock, HLC, that seeks to combine logical clocks and physical clocks. The nodes exchange their respective physical time and the logical clock is the maximum heard physical time. The article mentions applications for transaction ordering and performing snapshot reads in globally distributed databases. However, the suitability for timeout detection is not discussed and the article does not disclose any kind of distributed timeout detection.

It is an object of the present invention to provide a more robust method for detecting a timeout of an action, wherein the timeout is defined in terms of a physical time duration (or in terms of any parameter with a bijective relationship with a physical time duration).

This object is solved according to the present invention by a method of the kind defined in the outset, wherein each node stores an action log of pending actions, the method comprising the following steps carried out by at least one of the nodes: receiving a logical time update from at least another one of the nodes; merging the logical time update into a shared state to obtain an updated shared state; determining a common logical time from the updated shared state; checking each of the pending actions in the action log for a timeout condition based on the determined common logical time; and, upon detecting a timeout of one of the pending actions, interrupting the action by the present node.

The shared state may for example be a collection of the latest logical time updates received from the nodes in the environment. The node may keep the last logical time update from each node. The shared state can be locally stored at the respective node.

When a node receives a new logical time update it replaces the previous logical time update from the node that sent it in the collection forming the shared state. The logical time update may comprise an identifier of the node sending the logical time update. The identifier can be used to replace previous logical time updates from the same node with the newly received logical time update. The identifier may be a unique identifier.

Each node can evaluate and decide the timeout condition independently. This effectively provides a leaderless determination of timeout. No leader is required to determine the event of a timeout or to coordinate any potential steps following a timeout event. More general, no communication at all with other nodes is required to make the timeout decision. Hence, no interaction is required between the nodes to agree on the timeout (i.e., the method is non-interactive). Consistent timeout decisions across multiple nodes are achieved through the common logical time. As long as the same logical time updates are received by all nodes and are merged into their respective shared state, they all undergo the same shared states in the same sequence. The common logical time can be designed to trace or be proportional to physical time. More specifically, durations denoted in common logical time may be directly proportional to durations in the physical time. A duration refers to a time difference between two wall clock times in contrast to an integer logical time, which may be defined in terms of increments that do not have a fixed or pre-defined physical frequency or expectation value thereof. Hence, the common logical time of this disclosure must not be confused with e.g., Leslie Lamport's logical time.

The environment mentioned above may be represented by a list of online nodes participating in the parallel, distributed processing system. According to one embodiment of the present method, there can be a node timeout. The node timeout can be a well-known configuration parameter across all participating nodes. When the most recent logical time update received from a particular node is older than the presently determined common logical time minus the node timeout (i.e., outside the timeout window), the respective node may be considered failed and removed from the environment (i.e., dropped from the list of online nodes). As a result, the last (and timed out) logical time update from that node is removed from the shared state. From then on, the common logical time is determined without any time information from the removed node. For the purpose of evaluating the node timeout, each logical time update may be stored in association with a node timeout condition, which is based on the common logical time determined after merging that particular logical time update and on the pre-defined node timeout. Before and until the node is removed from the environment (i.e., within the timeout window), its last logical time update remains part of the shared state and potentially influences the determined common logical time (it may be ignored prior to the node timeout for becoming an outlier, see below)

The common logical time proposed in the present disclosure may differ slightly, and variably, from physical wall clock time, however it can provide a consistent deterministic approximation thereof that can be used to determine e.g., if an action has been handled within a given time. Specifically, the timeout condition being based on the determined common logical time means that the timeout condition may evaluate a time period in common logical time. A positive evaluation of the timeout condition is also referred to as logical timeout in this disclosure. The logical timeout can be derived from the common logical time at the moment the respective action has started (e.g., when an action message triggering the action has been received or when the action has been assigned) plus an interval that may be attached to the action or may have been predefined or pre-agreed amongst all nodes. This logical timeout is an event for a particular action that is—by means of the disclosed method—scheduled to be triggered asynchronously at each node for that action. The checking of the timeout condition, i.e., the examination whether a logical timeout event is due, can be carried out by each node individually and independently whenever a logical time update is received and the common logical time is updated on that particular node. As this requires no further communication between the nodes, it makes the system more efficient and robust than systems relying on a leader to evaluate a timeout condition and distribute the result of this evaluation. With the disclosed method, each node can start with any of its timeout-related activities immediately, independently and concurrently after detecting a timeout of one of the pending actions. Specifically, each node can immediately interrupt the action. Following the interrupt, it can immediately perform any distributed reversal activity, including related local activities like local cancellation, clean-up and/or rollback steps, related to or associated with the interrupted action, e.g., if the action is terminated.

In some embodiments of the invention, a leader of an action corresponding to a transaction may request responses from the other nodes, e.g., to create a quorum. These requests may timeout in the same way as the transaction, in which case the triggering transaction may also fail (depending, e.g., on whether the quorum can be completed without the timed-out response). The action log stores at least the pending actions and those pending actions are checked for a timeout condition. As soon as an action has been handled by the leader, it is not pending any longer and consequently cannot cause a timeout. Pending actions are not limited to actions submitted from entities other than the nodes. It also includes actions or messages belonging to a set of related messages, e.g., according to a workflow and specifically to a transactional workflow. In such cases, there may be a cascade or hierarchy of interdependent actions. The action log may optionally be an ordered action log. In this way, it can be enforced that the execution of timeouts on a local node is carried out in the same order as the actions were received initially even if multiple actions had the same timeout condition (e.g., if they would all be submitted between the same two updates of the common logical time). In that case, the order of the action log would preserve transactional integrity. E.g., if 10 actions (a1 . . . a10) were received and attached the same timeout condition and actions 7, 3 and 6 would in fact time out, then the order of the action log would establish that the action a3 was submitted before a6, which was before a7. Hence, any timeout and rescheduling needs to be done for a3 first, then a6 then a7. This preserves referential and transactional integrity. Another solution to preserve the order of actions across time outs would be to enforce a minor time increment upon each action message. These increments would propagate to the timeout conditions of otherwise simultaneous action submissions. Hence, the timeout conditions would be slightly different. By evaluating the timeout conditions in order of their “age” (i.e., the distance between the present common logical time and the moment of the earliest possible fulfillment of the particular timeout condition), the order of the actions would be maintained even if the action log were not inherently ordered.

Optionally, the method assumes that each node stores for each pending action an assignment to one of the nodes of the system, wherein the method further comprises the following steps carried out by the same node as before: upon detecting a timeout of one of the pending actions, rescheduling the timed-out action based at least in part on the updated shared state, wherein the rescheduling result comprises a new assignment of the action to one of the nodes; updating the action log with the new assignment and a new timeout condition relative to the common logical time; upon detecting that the new assignment is to the present node, performing the action (e.g., starting with a job, like processing a transaction). In this variation, the method achieves leaderless non-interactive rescheduling as one of the possible consequences of a timeout. This makes the distributed processing and execution of the action more resilient against failures of a leader.

One step in the rescheduling may be implemented as a leader election. The elected leader is the node to which the action is newly assigned. In order to avoid an influence on the result by a single or a minority of misbehaving nodes, the leader election may be based on unpredictable information. The present disclosure allows the same leader to be determined by each node independently for each action, in particular each transaction, and without any further message exchange amongst the nodes. For this purpose, the unpredictable information may comprise previously exchanged contributions from at least two nodes. These contributions may be random strings of characters. The contributions may be distributed together with all or some of the logical time updates. For example, they may be part of a control message comprising the logical time update. The contributions are combined in a deterministic way to obtain the unpredictable information, for example by ordered concatenation, wherein the order may be based on a node identifier or on the order of the considered contributions. The contributions may be part of the shared state in the same way as the logical time updates, e.g., by keeping only the latest contribution from each node in the shared state. The leader election may determine a node in a deterministic way from the unpredictable information, for example using one or more rounds of cryptographic hashes over the unpredictable information and subsequent modulus of the final hash value based on the number of nodes in the environment. If the leader election determined the same node, to which the action was assigned when the timeout was detected, a re-election may be triggered until a different node is determined. The re-election may for example add one or more additional rounds of hashing before the modulus computation.

In one embodiment of the present method, the logical time update can comprise the local physical time of the node sending the logical time update, wherein the shared state comprises the most recent reported local physical time of each node. The logical time update may comprise the local timestamp of the node sending the logical time update at the moment when the sending of the logical time update was prepared.

The common logical time may for example be the average or median of one or more local physical times comprised in the shared state. In principle, any method is acceptable to derive the common logical time from the shared state. What matters is that all nodes use the same method in order to arrive at the same result when determining the common logical time. Moreover, methods that are robust to statistical variations of the individual local physical times reported by the nodes have the advantage of lower fluctuations. This can result in a more stable frequency of detected timeouts (assuming the frequency of submitted actions is also stable).

In some embodiments it may be desirable that the common logical time is constrained to be strictly increasing. This ensures that actions that are submitted at different times and have the same timeout condition timeout in the same order they were submitted. Consequently, they are potentially also rescheduled in the same order they were initially submitted. This is particularly useful in applications with different actions depending on one another. For example, in the context of a distributed transaction management system, to avoid double-spending and to facilitate a consistent view on available resources it is important that the order in which the actions (i.e., transactions) timeout and are canceled is predictable and consistent with the order in which the actions are submitted. To achieve a strictly increasing common logical time, if the prospective common logical time (i.e., the average or median of one or more local physical times comprised in the shared state) is less than the present common logical time (i.e., before the update of the shared state), the common logical time can either be left unchanged and remain the same or be incremented by a fixed tiny amount to ensure it always changes. As all nodes arrive at the same shared state and have the same updates and use the same rules (and—optionally—constraints), they will determine the same common logical time. In general, it is not required for the common logical time to change upon every logical time update, because the order of actions and timeouts will be maintained in the same way it is maintained for multiple actions being submitted between two logical time updates, which naturally also have the same common logical time and thus the same timeout condition attached (in the simplest case of one predefined timeout interval for all actions).

In this context, the local physical times comprised in the shared state can be filtered for outliers before determining the common logical time from the remaining local physical times. The filtering may be based on a common threshold, which is consistently applied by each node independently from one another. The common threshold may comprise discarding a fixed number or fixed ratio of the most extreme local physical times comprised in the shared state before determining the common logical time from the remaining local physical times. The common threshold may also be defined as a fixed maximum time deviation or as a relative maximum time deviation (e.g., two standard deviations), wherein all local physical times beyond that threshold from an unfiltered mean (or median) are disregarded for determining the common logical time. According to another variation, the common threshold may also be defined as a fixed maximum time deviation plus the median (or any other quantile) difference of all possible pairs of local physical times.

Optionally, the logical time update from at least another one of the nodes is received via a totally ordered message log mechanism. This creates a reliable framework for total recoverability. In this instance, the disclosed method provides total recoverability and time synchronization based on ordered communication in distributed environments.

For example, at least all control messages or all control and all action messages may be received via the same totally ordered message log mechanism. The nodes of the parallel, distributed processing system can periodically and asynchronously communicate messages like the control messages defined above to one another through the totally ordered log mechanism. The totally ordered message log mechanism ensures that each node receives every message in exactly the same order and exactly once. Totally in this context means that the order of messages is kept and guaranteed across all nodes. The mechanism provides a totally ordered log of messages that is accessible to all nodes and may be kept in a centralized manner. Each new message submitted to the totally ordered log is appended to the log and can be configured to be delivered to each node exactly once. For each node, a pointer is maintained that points to the last position in the log that the respective node is aware of (i.e., the last message that has been received by the node). Receiving new messages corresponds to advancing the pointer along the same sequence (log) of messages for each node.

As all nodes receive the same messages in the same order, the shared state evolves in the same way on each node and they determine the same common logical time, the same timeouts and the same action assignments without any further communication. In other words, because the communication amongst the nodes is based on an ordered log, each node sees the same order of messages and hence comes to the same result of a potential logical timeout happening at the same point within the flow of messages in the log, and hence at the same point of logical time. The system can, for example, switch leaders deterministically, automatically and simultaneously (with respect to logical time) based on the messages received via the totally ordered message log.

For a node that stops receiving messages, neither the common logical time is recalculated, nor any action messages are received after that (in the case where all messages are received via the same channel, e.g., the same ordered log mechanism). Once the node starts receiving messages again, it will be able to replay all the steps that happened at the other nodes in exactly the same order. Since all messages are kept on the totally ordered log service they are not exposed to network or similar risk and can simply be retrieved once the stopped node reconnects. Replay guarantees that the failed node will arrive at exactly the same state once it has caught up to the last message received.

One example of an available product providing an implementation of a suitable totally ordered message log mechanism is Apache Kafka (https://kafka.apache.org/). Its architecture is typical for similar mechanisms and services: requests are sent to a service-cluster with a leader to take action on the incoming requests. Similar effects might be achieved with message broker services, for example IBM MQ, RabbitMQ, Google Cloud Pub/Sub, Amazon MQ, KubeMQ or ZeroMQ. In general, these services keep messages persistent until every node has read them.

The method carried out by at least one node may further comprise: periodically sending a logical time update to the nodes of the system. The logical time updates can be distributed to the other nodes of the distributed system for example by broadcasting or multicasting, i.e., using a totally ordered log protocol. The periodical sending can be triggered by each node independently, for example by a local timer. Each logical time update can be part of a more general control message. The control message may further contain a unique identifier of the node sending the message and/or a random seed (e.g., a random string of characters). The logical time update may comprise the local timestamp where the message was generated.

Optionally, the method can comprise: receiving an action submission; scheduling the submitted action based at least in part on the last shared state, wherein the scheduling result comprises an assignment of the action to one of the nodes; including the assignment and a timeout condition relative to the common logical time corresponding to the last shared state in the action log. The action submissions can be interspersed with the logical time updates. For example, the logical time updates may be contained in control messages, while action submissions may be contained in action messages, which have a different format and content than control messages. Each submitted action represents something to be performed in the environment. Each action message may contain the details of the action, a unique identifier for that message and a cryptographic signature over the message, generated by the sender using a private key known only to them. The present disclosure allows the same timeout condition to be determined by each node independently for each submitted action, in particular each transaction, and without any further message exchange amongst the nodes.

The scheduling may be performed accordingly in the same way as the rescheduling described above. The unpredictable information used for leader election may also comprise the cryptographic signature contained in the action message.

The object mentioned above is also solved according to the present invention by a node of a distributed transaction management system configured to perform the method described above or any variations or combinations thereof.

Finally, the object mentioned above is also solved according to the present invention by a distributed transaction management system comprising two or more such nodes. In such configurations all nodes contribute to a particular action: for example, they have to block funds locally, and the leader collects replies from all nodes, comprising votes on the requested action. Upon a timeout, a distributed activity is required across all nodes, e.g., a rollback can be performed comprising the unblocking of funds on each node.

Depending on the type of transaction and use-case, upon timeout a new master or leader can choose to reschedule the action, or let the client know that it has been aborted and terminated. The present disclosure concerns in particular the handling of timeout events in distributed transaction management systems, such as a distributed ledger (also called a shared ledger or distributed ledger technology or DLT), properly and non-interactively.

Referring now to the drawings, wherein the figures are for purposes of illustrating the present invention and not for purposes of limiting the same,

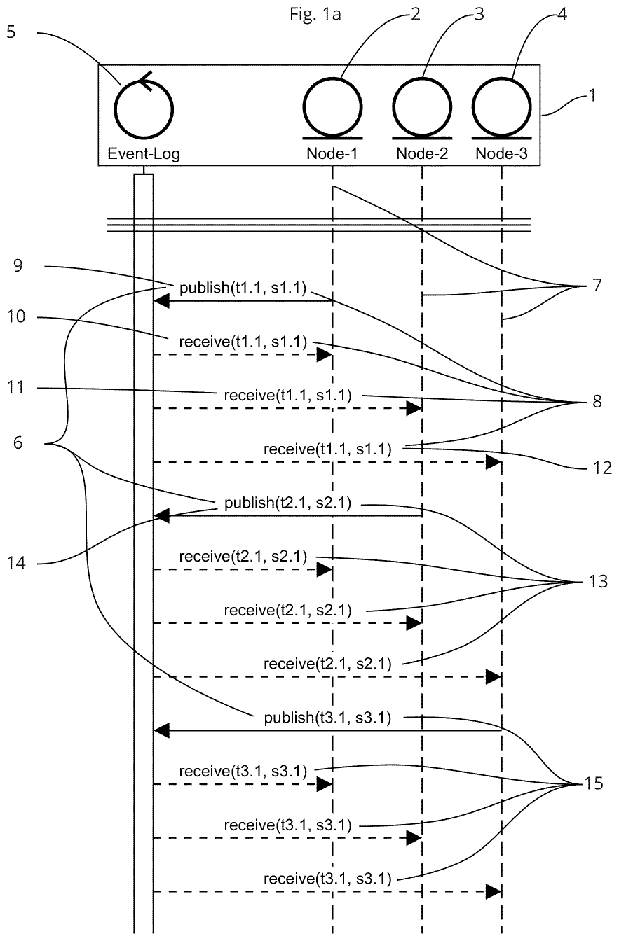

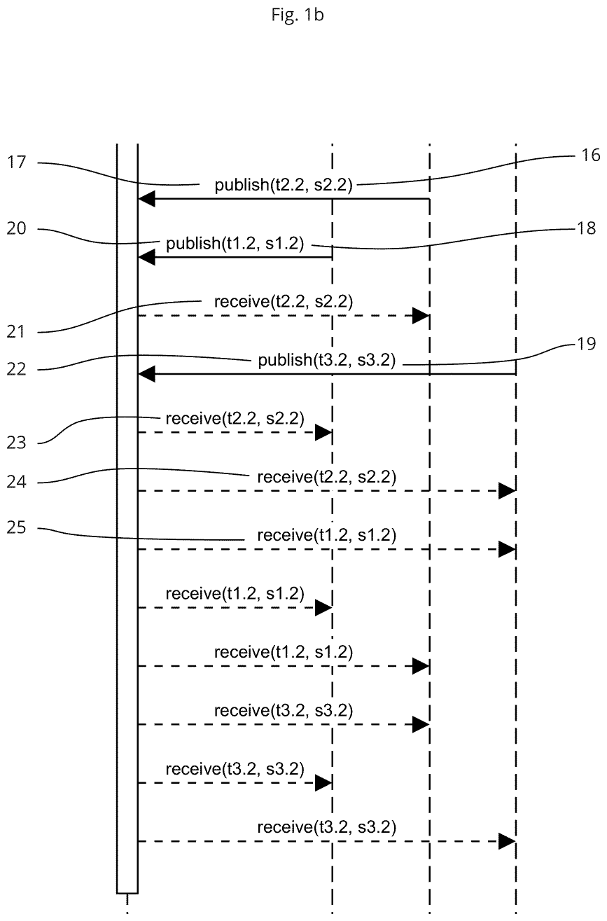

FIG. 1a-b show a sequence diagram illustrating the exchange of logical time updates within a parallel, distributed processing system according to the present disclosure; and

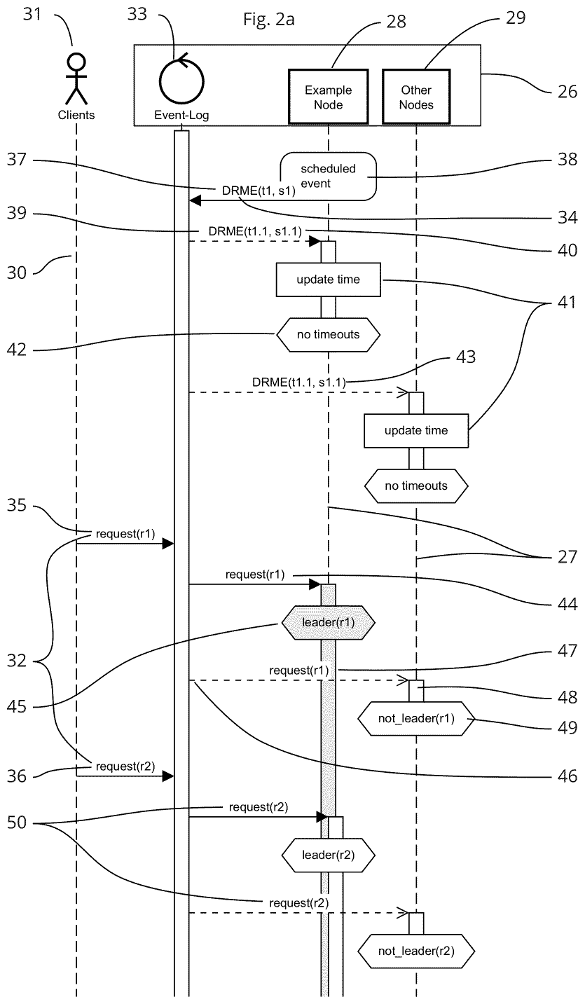

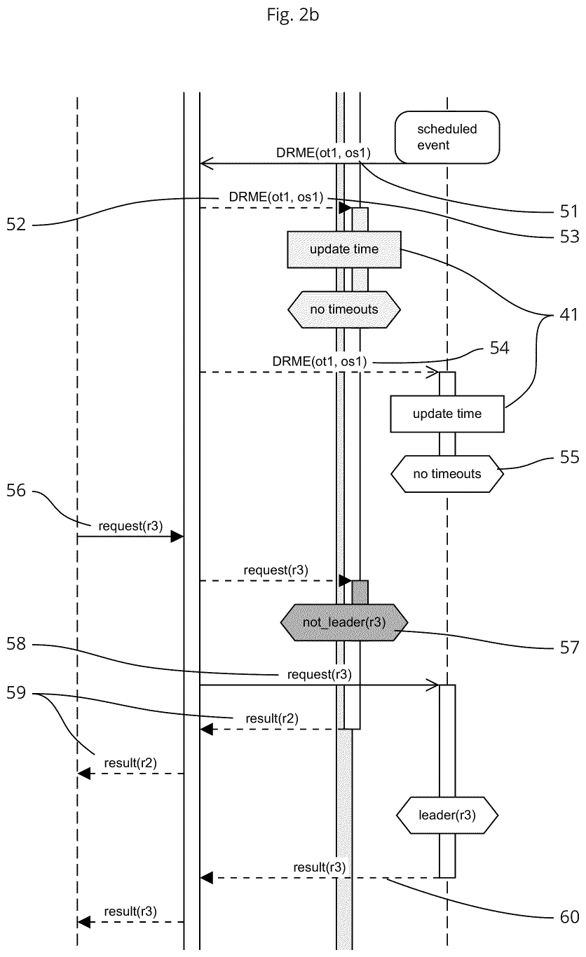

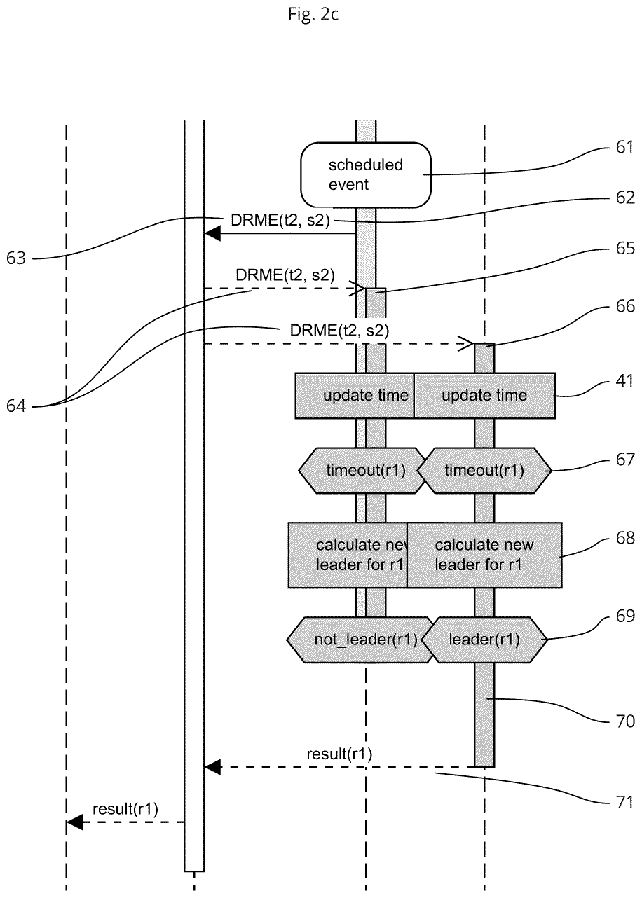

FIG. 2a-c show a sequence diagram illustrating three action requests submitted to a parallel, distributed processing system according to FIG. 1a-b, of which one action request is rescheduled before completion after a timeout detected according to the present disclosure.

FIG. 1a-b shows a parallel, distributed processing system 1 comprising three nodes 2, 3, 4 and an event log 5. The interactions within the system 1 and specifically the messages 6 exchanged between the nodes 2, 3, 4 are illustrated in time sequence along the vertical lifelines 7. The event log 5 provides a totally ordered message log mechanism as will be explained in more detail in connection with the messages in the following:

The first message 6 in FIG. 1a is a first control message 8 sent by the first node 2 to the event log 5 and thereby published 9. The first control message 8 comprises a first logical time update t1.1 and a first random string s1.1 of characters forming a contribution of the first node 2 to an unpredictable information which can later be used for leader election (see FIG. 2a). After reception by the event log 5, the first control message 8 is distributed within the system 1. For this purpose, the event log 5 notifies all nodes 2, 3, 4 of the availability of the first control message 8 in the event log 5 via a broadcast or multicast message (not shown, optional). Each of the nodes 2, 3, 4 receives the first control message 8 from the event log 5. According to the sequence shown in FIG. 1a, the first node 2 receives 10 its own first control message 8, then the second node 3 receives 11 the first control message 8 and finally the third node 4 receives 12 the first control message 8.

The next message 6 in the sequence is a second control message 13 published 14 by the second node 3 by sending it to the event log 5. The second control message 13 comprises a second logical time update t2.1 and a second random string s2.1 of characters forming a contribution of the second node 3 to an unpredictable information which can later be used for leader election (see FIG. 2a). The distribution of the second control message 13 is similar to that of the first control message 8 as discussed above.

The same procedure is repeated for a third control message 15 from the third node 4. The third control message 15 comprises a third logical time update t3.1 and a third random string s3.1 of characters forming a contribution of the third node to an unpredictable information which can later be used for leader election (see FIG. 2a).

In the above examples, the control messages 8, 13, 15 were distributed to the nodes 2, 3, 4 in order and all nodes received the respective logical time updates t1.1, t2.1, t3.1 before the next control message was published. In practice, the chronological order can be completely different as will be demonstrated by the examples shown in FIG. 1b. The first message in FIG. 1b is a fourth control message 16 sent by the second node 3 to the event log 5 and thereby published 17. As in FIG. 1, all control messages 16, 18, 19 in the examples in FIG. 1b comprise a logical time update tn.c from the node n publishing the control message as well as a random string sn.c of characters as contribution from the same node. Both are subscripted in FIG. 1a-b by two indices: the first index n identifies the originating node and the second index c is a local counter of that node. For example, t3.2 represents the second (c=“2”) logical time update (“t”) that has been published by the third node (n=“3”). Right after publication 17 of the fourth control message 16, the first node 2 publishes 20 a fifth control message 18 to the event log 5. At this point, none of the nodes 2, 3, 4 have received the fourth control message 16 yet. The event log 5 guarantees, that the fifth control message 18 will not be distributed to any node that has not yet received the fourth control message 16. Next, the fourth control message 16 is distributed (back) to and received 21 by the second node 3. Then, the third node 4 sends and thus publishes 22 a sixth control message 19 to the event log 5. At this point, none of the nodes 2, 3, 4 have received the fifth control message 18 or sixth control message 19 and none except for the second node 3 have received even the fourth control message 16. The following messages demonstrate the ordered distribution of the control messages 16, 18, 19 to all nodes 2, 3, 4 until all nodes have received even the sixth control message 19. However, for the sake of generality, this order is not necessary either. There may be further new control messages from any of the nodes even before its own previous control messages are distributed to all nodes.

The next message shown in FIG. 1b is the fourth control message 16 being distributed to and received 23 by the first node 2. At this point in time, the third node 4 is still in the same state as after receiving the third control message 15 (FIG. 1a), i.e., its shared state and common logical time have not changed since then (see FIG. 2a below). Then the fourth control message 16 is distributed to and received 24 by the third node 4. Right after, the fifth control message 18 is received 25 by the third node 4, which is now the first node in the system 1 to receive this update and, thus, at this point has surpassed the other nodes regarding its common logical time. Then the fourth control message 16 is finally distributed to the first node 2 and the fourth control message 16 and fifth control message 18 are distributed to the second node 3. Finally, the first node 2 and then the third node 4 receive the sixth control message 19.

FIG. 2a shows a parallel, distributed processing system 26 similar to FIG. 1a, wherein for simplicity the sequence diagram comprises only two lifelines 27 for a first node 28 and a second node 29. The second node 29 optionally represents any number of other nodes, which may behave the same (except for the last part in FIG. 2c). There is an additional lifeline 30 representing a client 31 submitting actions to the system 26 by sending action requests 32 to the event log 33. The sequence diagram illustrates the distribution of the first control message 34 similar to FIG. 1a and a first action request r1 and second action request r1 submitted 35, 36 by the client 31.

The first message in FIG. 2a is a first control message 34 (“DRME” is shorthand for “Distributed Random Master Election”, a method described in “A computer-implemented method for the random-based leader election in a distributed network of data processing devices”, published under WO 2020/148663 A1). The first control message 34 comprises a first logical time update t1 and a first random string s1 of characters forming a contribution of the first node 28 to an unpredictable information which is later used for leader election. The publication 37 of the first control message 34 is triggered by a timer operated by the first node 28, which calls a scheduled timer event. The timer event may be scheduled periodically at a fixed interval, e.g., every second or every 250 milliseconds, based on a local system clock. The timer interval may also be set to vary randomly within a predefined range, e.g., 2-4 seconds, in order to avoid fixed communication patterns. The event handler 38 of the scheduled timer event prepares and dispatches the first control message 34 to the event log 33. During preparation, the local physical time of the first node 28 is determined, e.g., by querying a local system clock, and used as the logical time update t1. The random string s1 can be created with a random number generator, for example including a stochastic entropy source, and optionally one or more rounds of hashing. In this example, t and s are used to denote time and random information published by the first node 28, and ot and os denote time and random information published by the second node 29. Like in FIG. 1a, the first control message 34 is then distributed 39 from the event log 33 back to the first node 28. During distribution, the logical time update ti and the random string s1 are associated with an identifier of the originating node, like in FIG. 1a-b. The first node 28 receives 40 the first control message 34 originating from itself. It performs an “update time” routine 41. This routine 41 comprises merging the logical time update into a shared state to obtain an updated shared state. The shared state comprises the most recently reported local physical time of each node. From the updated shared state, the first node 28 determines a common logical time. To determine the common logical time, the first node 28 filters the local physical times comprised in the shared state for outliers. The filter may for example be configured to remove at most 10% of the reported local physical times (i.e., updates from at most 10% of the nodes), such that at least 90% of the nodes have a vote in the common logical time. The filter may for example determine a mean and standard deviation and remove entries outside two standard deviations. Then the first node 28 computes the (new, filtered) mean value of the remaining local physical times. This mean value determines the new common logical time. Once the common logical time is determined, the first node 28 checks 42 a local action log for any pending actions and for each of the pending actions in the action log checks whether a timeout condition based on the determined common logical time is met (i.e., the condition evaluates to a timeout). In the present example, at this point, there are no pending actions in the action log. The first node therefore detects no timeout.

The next message in the sequence diagram is the distribution of the first control message 34 to the second node 29. The second node receives 43 the first control message 34 and follows the same procedure as described above for the first node 28, only that the first control message 34 and the logical time update t1.1 comprised therein is now from another one of the nodes. Again, no timeout is detected.

Then, the client 31 submits 35 the first action request r1. The first action request r1 is submitted 35 to the event log 33 similar to a control message. The first node 28 receives 44 the first action request r1 from the event log 33. Following its reception, the first node 28 stores the first action in its action log of pending actions. Then the first node 28 schedules the first action based on the last shared state (i.e., determined after receiving the latest control message preceding the action submission). In other words, the first node 28 determines 45 a leader for the first action. The scheduling result comprises an assignment of the action to the first node 28 as the leader for this action. To determine the leader, the first node 28 performs a leader election algorithm, which is based on the first action request r1 as well as the shared state and specifically the most recent random strings s1 of characters contributed by each of the nodes 28, 29 to form an unpredictable information. The leader election algorithm identifies the first node 28 as leader for the first action. Hence, the first node 28 changes the local action log to include the assignment of the first action to point to itself. Moreover, it includes in the action log a timeout condition relative to the common logical time corresponding to the last shared state. Following this decision, the first node 28 proceeds to process or carry out the first action since no other actions are pending and assigned to the first node 28 at this point.

The next message in FIG. 2a is the distribution 46 of the first action request r1 to the second node 29. The second node 29 (representative for any other node in the system) receives 47 and processes 48 the first action request r1 in the same way described in connection with the first node 28 above. However, by finding the assignment of the first node 28 to the first action in the local action log of the second node 29, the second node 29 determines 49 that it is not the leader for the first action and therefore finishes its processing, because it does not have any pending actions assigned to itself.

The following message in FIG. 2a is a second action request r2 sent 36 by the client 31 to the event log 33. The second action request r2 is distributed 50 the same way as the first action request r1. Like for the first action, the leader election again determines the first node 28 as the leader for the second action. Now, both actions in the action log are assigned to the first node 28 and the second node 29 again remains idle after finishing the processing of the distributed action request r2. This demonstrates that the leader election is independent from any other action requests, which can lead to an unbalanced assignment of actions among the available nodes. However, the leader election is also not relying solely on the shared state, which would obviously lead to identical assignments as long as no new control message is published. Instead, the leader election also takes the action request r1, r2 itself into account, such as via digital signature provided with the action request, which makes it difficult to intentionally influence the leader election to arrive at a particular predefined outcome.

FIG. 2b continues the sequence diagram of FIG. 2a, with the same lifelines. The first message in FIG. 2b is a second control message 51 published by the second node 29 in response to a scheduled event in the same way as has been described in detail in connection with FIG. 2a for the first node 28. The second control message 51 comprises a logical time update ot1 from the second node 29 as well as a random string os1 of characters from the second node 29 and is distributed 52 from the event log 33 and received 53 by the first node 28. In response to receiving the logical time update contained in the second control message 53, the first node 28 performs the “update time” routine 41 as described above. In contrast to the first occurrence, the action log is now not empty, but comprises two pending actions corresponding to the first action request r1 and the second action request r2. However, none of the two pending actions have timed out and their respective timeout conditions being evaluated by the first node 28 do not result in a timeout event. The first node 28 therefore continues processing both actions. The same is found independently by the second node 29 after receiving 54 the second control message 51. No timeouts are detected 55 and hence the second node 29 remains idle.

Further down in FIG. 2b, the client 31 submits 56 the third action request r3 to the event log 33. The third action request r3 is distributed to the first node 28. The first node 28 performs the leader election algorithm and this time determines that the second node 29 is the leader for the third action. After determining that it is not itself to be the leader of the third action, the first node 28 finishes 57 the processing of the third action request r3. The next message in FIG. 2b is the third action request r2 being distributed 58 to the second node 29. The second node 29 carries out the same leader election algorithm and naturally determines that it is itself the leader for this action. Consequently, it starts processing the third action after having it assigned to itself in the action log.

While the second node 29 processes the third action, the first node 28 finishes processing of the second action. After finishing, it provides 59 the result of the second action to the event log 33 from which the client 31 can retrieve the result. The other nodes 29 by following the event log 33 detect that a result of the second action has been provided and remove the second action from their action log. Next, the second node 29 finishes processing of the third action and also provides 60 the result of the third action to the event log from which the client 31 can retrieve the result. This time the first node 28 by following the event log 33 detects that a result of the third action has been provided and removes the third action from its action log. At the bottom of FIG. 2b, only the first action is unfinished and it is still assigned to the first node 28. By the removal of the completed actions from the action logs, those actions cannot time out due to any logical time update that succeeds the provided result on the event log 33.

FIG. 2c continues the sequence diagram from FIG. 2b and shows an example to illustrate a distributed timeout event according to the present disclosure. In the beginning of FIG. 2c, the local timer of the first node 28 triggers an event handler for the scheduled event 61 to publish a new control message. The first node 28 determines its local physical time and generates a new random string of characters and includes both in a third control message 62 published 63 to the event log 33. The event log 33 distributes 64 the third control message 62 to all nodes 28, 29. The first node 28 and second node 29 both receive 65, 66 the third control message 62 from the event log 33. The following steps are shown as simultaneous in FIG. 2c to illustrate that both nodes 28, 29 carry them out independently and concurrently. The first node 28 uses the logical time update t2 contained in the third control message 62 as an input parameter for another round of the “update time”routine 41 that has been described in connection with FIG. 2a. Specifically, it determines a new common logical time from the updated shared state. During evaluation 67 of the timeout condition of the pending actions, i.e. of the first action r1, it detects that the determined common logical time fulfills the timeout condition for the first action r1. For example, the first action r1 may have defined the common logical time when the first action request r1 was received plus a fixed time interval as a latest point of completion of the first action r1 and the common logical time is now later than this latest point of completion. Upon detecting the timeout of the first action r1, the first node 28 interrupts the first action. This includes canceling the processing of any remaining steps needed to complete the first action on the first node 28. It can also include rollback steps to undo any changes prepared in relation to the first action. Then, the first node 28 reschedules 68 the first action based on the current shared state. The rescheduling 68 comprises a new assignment of the first action based on a new round of leader election. This time, the second node 29 is determined as the leader for the first action. Optionally, the first node may compare the new assignment with the old assignment and reject any assignments to the same node. Having determined the second node 29 as the new leader for the first action, the first node updates the action log and stores this new assignment in the action log and finishes processing of the third control message.

The second node 29 performs the same steps and determines and assigns itself as the new leader for the first action. Consequently, upon detecting 69 that the new assignment is to the present node, the second node 29 proceeds to perform 70 the first action, e.g., by processing its actions steps from the beginning. After finishing the first action, the second node provides 71 the result of the first action to the event log 33 from which the client 31 can retrieve the result.

Below, another exemplary embodiment of the present disclosure will be illustrated in pseudocode format, with the following abbreviations:
Distributed system(S)
   N processes or nodes (Pᵢ, i={1..N})
Totally ordered log (L)
A leader election function (H) producing Pᵢ from a set of input parameters, e.g., by hashing over the concatenated input parameters and computing the Nth modulus of the hash value
An average function (avg) taking a set of times and calculating a median time value less outliers
An agreed-upon timeout interval I that is shared among all processes

Using this notation, the following activities contribute to establishing the common logical time according to this embodiment:
Pᵢ=any
   timer Tᵢ triggers regularly, e.g. every x milliseconds
   send local time tᵢ and a random string sᵢ to L
Pⱼ=all (inclusive Pᵢ)
   receive sᵢ and tᵢ from L and store locally
      s[i]=sᵢ
      t[i]=tᵢ
   update logical time (lⱼ)
      lⱼ=avg(t[:all])

Continuing with this notation, the following activities contribute to scheduling an action submitted to the distributed system S, more specifically to the totally ordered log L, e.g., in the form of an action request sent by a client to L, according to this embodiment:
Pⱼ=all
   receive action (a) from L and store locally
      A[a]=a
   determine the leader Pₐ for a
      Pₐ=Pₗ, l=H(a,s[:all])
Pⱼ=Pₐ
   calculate the timeout time for the action a
      aₜᵢₘₑₒᵤₜ=l+I
   run a
P=Pₐ
   upon completion of a broadcast cₐ to L
Pⱼ=all
   receive completion cₐ from L
      delete A[a]

Finally, again continuing with the above notation, the following activities of the present embodiment contribute to a distributed detection of a logical timeout according to the present disclosure:
Pⱼ=all
   receive a control message tᵢ from L
   calculate a new logical time lⱼ
   check for any actions having a timeout time before the current logical time
      for each a∈A[a.timeout<lⱼ]
         perform local rollback activities on a
         determine a new leader (Pₐ) for a different than previous leader (Pₚ)
         Repeat until Pₐ≠Pₚ
         Pₐ=Pₗ, l=H(a, s[:all])
         if Pₗ=Pₚ then repeat the leader election function on the previous leader election function's result: H(l), H(H(l)), H(H(H(l))), . . . until Pₗ≠Pₚ
         On Pⱼ=Pₐ: reschedule the action as a′
         a′.timeout=lⱼ+I
         A[a′]=a′
         broadcast a′ to L

In a variation of the embodiment disclosed above, the update of the logical time (lⱼ), which was shown as lⱼ=avg(T), where T=t[:all] may be extended with an outlier determination protocol to become lⱼ=avg(T/T₀), where the outlier determination protocol is as follows:
An outlier interval Io is defined as a well-known configuration parameter across all participating nodes.
Let T be a set of times {t₁, . . . tₙ}, where n is the number of active nodes in the system,
Let t_{L} be the median time over all times in T,
Let d_{L} be the median difference between all (tᵢ, tⱼ) ∀i, j∈{1 . . . n},
Let o_{L}=d_{L}+Io
Then we define an outlier set of times To=tⱼ∈T ∀(tⱼ<t_{L}−o_{L}) V (tⱼ>t_{L}+o_{L})
As a result, all elements from T\To will be used to calculate the logical time.

Exemplary applications of the present disclosure include distributed transaction management systems such as distributed ledgers, e.g., for managing digital assets like a digital token or a digital currency. The managed transactions may also be representative of or decisive for physical transactions, like digital contracts. One of the technical effects that may be achieved with systems within the scope of the present disclosure is a deterministic, consistent, and predictable processing of actions and transactions. It may improve the responsiveness of distributed systems by creating an authoritative notion of time, thus enabling definitive decisions without the latencies involved with interactive architectures. For example, it allows a transaction to either be rolled back or retried if a consensus decision has not been received within the timeout period. This provides resilience against node failures and also the ability to unreserve previously reserved resources that otherwise would remain reserved (locked) forever. All without creating a single point of failure.

1. Method for interrupting an action in a parallel, distributed processing system comprising at least two nodes wherein each node stores an action log of pending actions, the method comprising the following steps carried out by at least one of the nodes:
receiving a logical time update from at least another one of the nodes,
merging the logical time update into a shared state to obtain an updated shared state,
determining a common logical time from the updated shared state,
checking each of the pending actions in the action log for a timeout condition based on the determined common logical time,
upon detecting a timeout of one of the pending actions, interrupting the action by the present node.

2. Method according to claim 1, characterized in that each node stores for each pending action an assignment to one of the nodes of the system, the method further comprising the following steps carried out by the same node:
upon detecting a timeout of one of the pending actions, rescheduling the timed-out action based at least in part on the updated shared state, wherein the rescheduling result comprises a new assignment of the action to one of the nodes,
updating the action log with the new assignment and a new timeout condition relative to the common logical time,
upon detecting that the new assignment is to the present node, performing the action.

3. Method according to claim 1, characterized in that the logical time update comprises the local physical time of the node sending the logical time update, wherein the shared state comprises the most recent reported local physical time of each node.

4. Method according to claim 3, characterized in that the common logical time is the average or median of one or more local physical times comprised in the shared state.

5. Method according to claim 4, characterized in that the local physical times comprised in the shared state are filtered for outliers before determining the common logical time from the remaining local physical times.

6. Method according to claim 1, characterized in that the logical time update from at least another one of the nodes is received via a totally ordered message log mechanism.

7. Method according to claim 1, characterized by further comprising periodically sending a logical time update to at least another one of the nodes of the system.

8. Method according to claim 1, characterized by further comprising:
receiving an action submission,
scheduling the submitted action based at least in part on the last shared state, wherein the scheduling result comprises an assignment of the action to one of the nodes,
including the assignment and a timeout condition relative to the common logical time corresponding to the last shared state in the action log.

9. Node of a distributed transaction management system configured to perform the method according to claim 1.

10. Distributed transaction management system comprising two or more nodes according to claim 9.
